(19) United States
(12) Patent Application Publication
(10) Pub. No.: US 2020/0024991 A1
(43) Pub. Date: Jan. 23, 2020

(54) GAS TURBINE

(71) Applicant: DOOSAN HEAVY INDUSTRIES & CONSTRUCTION CO., LTD., Changwon-si (KR)

(72) Inventor: Inkyom KIM, Changwon-si (KR)

(21) Appl. No.: 16/125,755

(22) Filed: Sep. 9, 2018

(30) Foreign Application Priority Data
Oct. 25, 2017 (KR) 10-2017-0139307

(51) Int. Cl. F01D 9/04; F01D 5/14

(52) U.S. Cl. CPC F01D 9/041; F05D 2220/32; F01D 5/143; F01D 5/147

(57) ABSTRACT

A gas turbine includes a turbine vane for suppressing a secondary vortex. The turbine vane includes a vane platform and a vane tip and is segmented into a plurality of span regions arranged across a span between the vane platform and the vane tip, each span region of the turbine vane including a specific airfoil that occupies a corresponding span region of the plurality of span regions and extends from a leading edge to a trailing edge of the turbine vane. The specific airfoil has a different thickness for each span region among a first span region having a first length that extends from the vane platform toward the vane tip; a second span region having a second length that extends from the first span region toward the vane tip; and a third span region having a third length that extends from the second span region to the vane tip.

### CROSS REFERENCE TO RELATED APPLICATIONS

The present application claims priority to Korean Patent Application No. 10-2017-0139307, filed Oct. 25, 2017, the entire contents of which is incorporated herein for all purposes by this reference.

### BACKGROUND OF THE INVENTION

### 1. Field of the Invention

The present invention relates to gas turbines and, more particularly, to a gas turbine including a turbine vane having multiple airfoil shapes according to span region.

### 2. Description of the Background Art

Generally, a gas turbine is a kind of combustion engine that converts thermal energy into mechanical energy by compressing air with a compressor to produce a high pressure compressed air, mixing fuel with the compressed air, burning the resulting fuel and air mixture to produce a hot, high pressure combustion gas, and jetting the combustion gas to a turbine, thereby rotating the turbine.

One of the most widely used turbines is structured such that a plurality of turbine rotor disks are arranged in multiple stages, a plurality of turbine blades are fixed to the outer circumferential surface of each turbine rotor disk, and a hot, high pressure combustion gas flows through turbine blade passages.

Among components of the turbine, the structure of a turbine vane will be described below in detail.

Referring to FIG. 1, a hot gas is fed to the surface of a turbine vane to flow in a direction indicated by arrows.

The hot gas first meets the leading edge 3a of a turbine vane 3 and then continuously moves toward the trailing edge 3b. When the hot gas flows in this way, a secondary vortex occurs. The secondary vortex originates in passage flows moving along the suction side surface and the pressure side surface 3e of the turbine vane, and then the generated secondary vortex moves along an end wall 3c.

The turbine vane 3 has a fillet 3d at a position near the end wall 3c. The fillet 3d is a simple structure for connecting the turbine vane 3 to the end wall 3c. Therefore, the contouring of the fillet 3d has not been paid much attention in terms of improvement in the flow stability of hot gas, which will contribute to reduction in the secondary vortex.

In order to improve the performance and efficiency of a gas turbine having the turbine vanes 3, a structure modification (i.e., contouring of) to the turbine vane is needed.

### SUMMARY OF THE INVENTION

Exemplary embodiments of the present invention are intended to provide a gas turbine including a turbine vane having an airfoil shape, the turbine vane being capable of suppressing a secondary vortex and improving flow stability of a hot gas.

In one embodiment of the present invention, a gas turbine may include a turbine vane that includes a vane platform and a vane tip and is segmented into a plurality of span regions arranged across a span between the vane platform and the vane tip, each span region of the turbine vane including a specific airfoil that occupies a corresponding span region of the plurality of span regions and extends from a leading edge of the turbine vane to a trailing edge of the turbine vane. The specific airfoil may be different for each span region of the plurality of span regions, and more specifically may have a different thickness for each span region of the plurality of span regions.

The plurality of span regions may include a first span region having a first length that extends from the vane platform toward the vane tip; a second span region having a second length that extends from the first span region toward the vane tip; and a third span region having a third length that extends from the second span region to the vane tip, and the turbine vane may have a maximum thickness in each span region that decreases stepwise across the span from the first span region to the third span region. Here, the leading edge of the turbine vane may have a curvature that increases across the span such that curvatures of the leading edges of the first to third span regions are arranged in decreasing order, while the trailing edge of the turbine vane may have a curvature that decreases along the span such that curvatures of the trailing edges of the first to third span regions are arranged in increasing order.

The specific airfoil of the first/second/third span region may include a first/second/third leading edge and a first/second/third trailing edge and may be formed to have at least one characteristic of a first/second/third angle of attack, a first/second/third chord length, and a first/second/third maximum thickness. The angle of attack may correspond to an angle between a direction of the corresponding leading edge and an inflow direction of hot gas fed to the turbine vane. The chord length may be a linear length from the corresponding leading edge to the corresponding trailing edge. The maximum thickness may be a greatest distance between a suction side of the specific airfoil and a pressure side of the specific airfoil. Here, the first angle of attack may range from 0° to 20°, the first chord length may range from 200 mm to 250 mm, and the first maximum thickness may range from 45 mm to 75 mm; the second angle of attack may range from 0° to 20°, the second chord length may range from 180 mm to 230 mm, and the second maximum thickness may range from 36 mm to 69 mm; and the third angle of attack may range from 0° to 20°, the third chord length may range from 180 mm to 200 mm, and the third maximum thickness may range from 36 mm to 60 mm.

The gas turbine may further include a pair of end walls respectively coupled to the platform and the tip of the turbine vane, and a junction between the turbine vane and at least one end wall of the pair of end walls. The junction may include a junction airfoil formed by respective curvatures of a suction side surface and a pressure side surface.

The gas turbine may further include a multistage turbine including a plurality of turbine stages consisting of a first turbine stage through a last turbine stage, wherein the turbine vane is provided to each turbine stage of the plurality of turbine stages. The turbine vanes of the first through last turbine stages may be respectively formed to have a maximum thickness that decreases from the first turbine stage to the last turbine stage, and/or may be respectively formed to have a chord length that increases from the first turbine stage to the last turbine stage.

In another embodiment, a gas turbine may include a multistage turbine including a plurality of turbine stages consisting of a first turbine stage through a last turbine stage, each turbine stage including a turbine rotor disk; and a plurality of turbine vanes coupled to the turbine rotor disk of each turbine stage. Each plurality of turbine vanes may include the above-described turbine vane, wherein the specific airfoil has a different thickness for each span region of the plurality of span regions. The turbine vanes of the first through last turbine stages may be configured to have a maximum thickness that decreases from the first turbine stage to the last turbine stage, and may be further configured to have a chord length that increases from the first turbine stage to the last turbine stage. The plurality of span regions may include the above-described first to third span regions, wherein the turbine vane has a maximum thickness in each span region that gradually decreases from the first span region to the third span region.

According to the embodiments of the present invention, it is possible to ensure flow stability of a hot gas by weakening a secondary vortex passage flow on the surfaces of a turbine vane by optimally contouring the turbine vane.

According to the embodiments of the present invention, a turbine vane includes a plurality of regions arranged in a span-wise direction and each region has a different airfoil shape. Therefore, it is possible to maintain flow stability of a hot gas along the suction side and the pressure side of the turbine vane, resulting in improvement in the aerodynamic performance of the turbine vane.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram of a contemporary turbine vane;

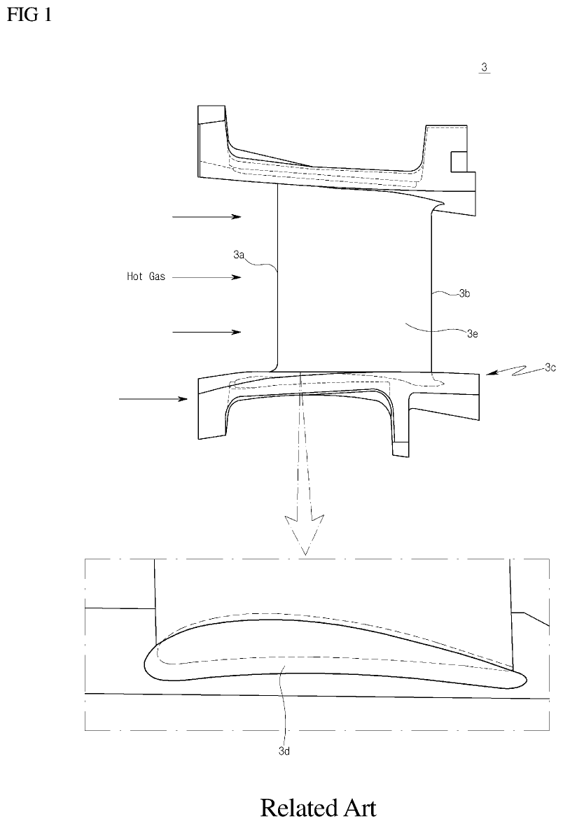

FIG. 2 is a cross-sectional view of a gas turbine including a turbine vane according to one embodiment of the present invention;

FIG. 3 is a perspective view illustrating a turbine vane according to one embodiment of the present invention;

FIG. 4 is a perspective view of a junction of an end wall and a turbine vane according to one embodiment of the present invention;

FIG. 5 is a cross-sectional view taken along a line A-A of FIG. 3;

FIG. 6 is a cross-sectional view taken along a line B-B of FIG. 3;

FIG. 7 is a cross-sectional view taken along a line C-C of FIG. 3; and

FIG. 8 is a view superposing cross-sections of a contemporary turbine vane and a turbine vane of the present invention.

### DETAILED DESCRIPTION OF THE DISCLOSURE

Prior to describing embodiments of the present disclosure, the overall construction of a gas turbine will be briefly described with reference to the accompanying drawings.

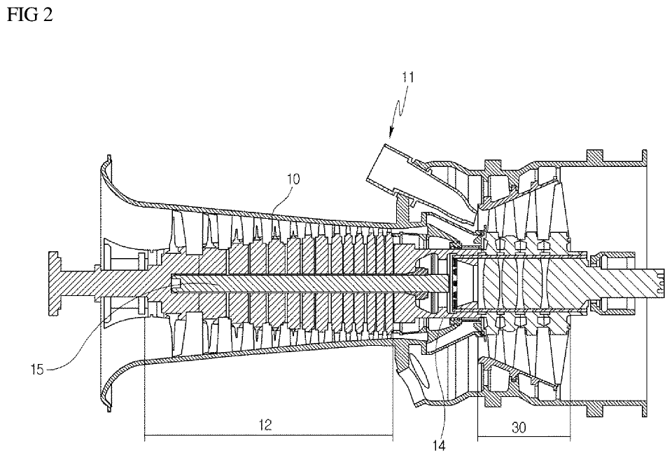

Referring to FIG. 2, a gas turbine includes a casing 10 serving as an outer shell and a diffuser that is disposed at the rear side of the casing 10 (the right side of FIG. 2) and through which a combustion gas passing through a turbine is discharged.

A combustor 11 that burns a mixture of fuel and compressed air is disposed at the front side of the diffuser.

In terms of flow directionality, a compressor section 12 is disposed at upstream side of the casing 10, and a turbine section 30 is disposed at the downstream side of the casing 10.

A torque tube 14 for transferring torque generated in the turbine section 30 to the compressor section 12 is installed between the compressor section 12 and the turbine section 40.

The compressor section 12 includes multiple (for example, fourteen) compressor rotor disks. The compressor rotor disks are attached to a tie road 15 so as not to be separated from each other in the axial direction.

The tie rod 15 is installed to extend in the axial direction and to pass through central holes of the compressor rotor disks that are arranged in the axial direction. Each compressor rotor disk has a flange protruding in the axial direction at a position near the outer periphery of the compressor rotor disk so that each compressor rotor disk is locked to prevent rotation relative to the adjacent compressor rotor disk.

Multiple blades are radially fixed to the outer circumferential surface of each compressor rotor disk. Each blade has a dovetail which is fitted in a corresponding slot formed in the outer surface of the corresponding rotor disk.

The dovetail may be either a tangential entry type or an axial entry type. Choice of the tangential entry type or the axial entry type may determined depending on the structure of any given gas turbine. Alternatively, the blades may retained by a different coupling means.

The tie rod 15 is arranged to pass through center holes of the multiple compressor rotor disks, in which one end of the tie rod 15 may be coupled to farthest upstream rotor disk and the other end may be fixed to the torque tube.

The structure of the tie rod may vary according to the type of gas turbine. Therefore, it should be noted that the structure of the tie rod is not limited to the example illustrated in the drawings.

For example, a single tie rod (called single-type) may be installed to pass through all of the center holes of the rotor disks. Alternatively, multiple tie rods (called multi-type) may be arranged in a circumferential direction. Further alternatively, a complex type employing both the single-type and the multi-type may be used.

Although not illustrated in the drawings, the compressor of the gas turbine are provided with a vane (also called a guide vane) next to the diffuser. The guide vane adjusts the flow angle of a high pressure fluid exiting the compressor and flowing into the inlet of the combustor such that the actual flow angle of the fluid matches with the designed flow angle. The vane is referred to as a deswirler.

The combustor 11 mixes the introduced compressed air with fuel and burns the fuel-air mixture to produce a hot, high pressure combustion gas which is then heated through an isobaric combustion process to the heat resistance temperature limits of components of the combustor and the turbine.

The combustion section of the gas turbine may consist of multiple combustors provided in a cell-type casing. Each of the combustors includes a burner having a fuel injection nozzle and the like, a combustor liner defining a combustion chamber, and a transition piece serving as a connection member that connects the combustor liner to the turbine.

Particularly, the combustor liner defines the combustion chamber in which the fuel injected through the fuel injection nozzle and the compressed air fed from the compressor are mixed and burned. In the combustion chamber defined by the combustor liner, a fuel and air mixture is combusted. A flow sleeve is installed to surround the combustor liner and the transition piece to provide an annulus space between the combustor liner and the flow sleeve. A fuel nozzle assembly is coupled to a front end (i.e., upstream end) of the combustor liner, and a spark igniter plug is installed in the side surface of the combustor liner.

The transition piece is connected to a rear end (i.e., downstream end) of the combustor liner to deliver the combustion gas, produced in the combustion chamber after the flame is started by the spark igniter plug, to the turbine section.

In order to prevent the transition piece from being damaged, a portion of the compressed air is fed from the compressor to the outer wall of the transition piece so that the outer wall of the transition piece can be cooled.

To this end, the transition piece is provided with cooling holes through which the compressed air (called coolant) is introduced to cool the body of the transition piece, and then the coolant flows toward the combustor liner.

The coolant used for cooling the transition piece then flows into the annulus space. A portion of the compressed air is externally introduced into the annulus space through cooling holes formed in the flow sleeve and the introduced air may collide against the outer surface of the combustor liner.

In the turbine section, the hot, high pressure combustion gas delivered from the combustor expands and then impinges on the turbine blades or glides over the turbine blades, causing rotary movement (mechanical energy).

A portion of the mechanical energy generated in the turbine is used to drive the compressor to compress air and the remaining mechanical energy is used to drive an electric generator to produce electricity.

In the turbine casing, stator vanes and rotor blades are alternately arranged. The combustion gas drives the turbine rotor blades, which in turn rotate and drive the output shaft to which the electric generator is connected.

To this end, the turbine section 30 includes multiple turbine rotor disks. Turbine rotor disks have the substantially same shape as the compressor rotor disks.

Each of the turbine rotor disks includes a flange that is used to combine the turbine rotor disk with the adjacent turbine rotor disk, and multiple turbine vanes 33 are radially arranged on the outer circumferential surface of the turbine rotor disks. The turbine vanes 33 may be fixed to the turbine rotor disks by a dovetail.

In the gas turbine having the structure described above, the intake air is compressed in the compressor section 12, then burned in the combustor 11, then fed to the turbine section 30 to drive the turbine, and finally discharged to the atmosphere via the diffuser.

A typical method of improving the performance of a gas turbine is to increase the temperature of the combustion gas flowing into the turbine section 30. However, in this case, the inlet temperature of the turbine section 30 rises. In this case, the turbine vanes 33 in the turbine section 30 come into trouble. That is, since the temperature of the turbine vanes 33 locally rises, thermal stress occurs. When this thermal stress lasts for a long period, the turbine vanes 33 may experience a creep phenomenon, which may result in the fracture of the turbine vanes 33.

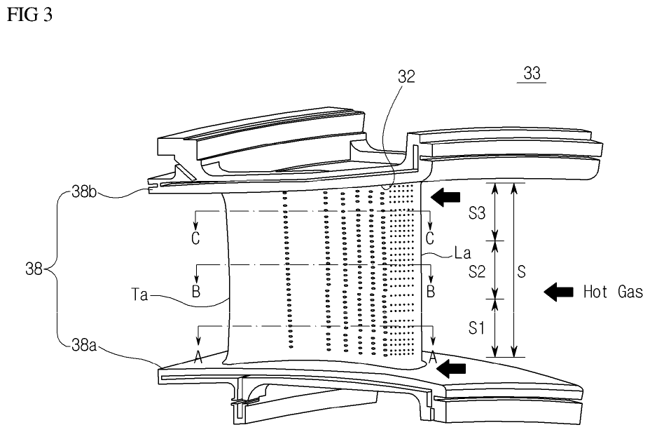

Next, a gas turbine according to one embodiment of the present invention will be described in detail with reference to the accompanying drawings, in which FIGS. 3-7 show a turbine vane included in the gas turbine. Thus, the embodiment presents a gas turbine and relates to the shape of a turbine vane 33 over which a hot gas glides.

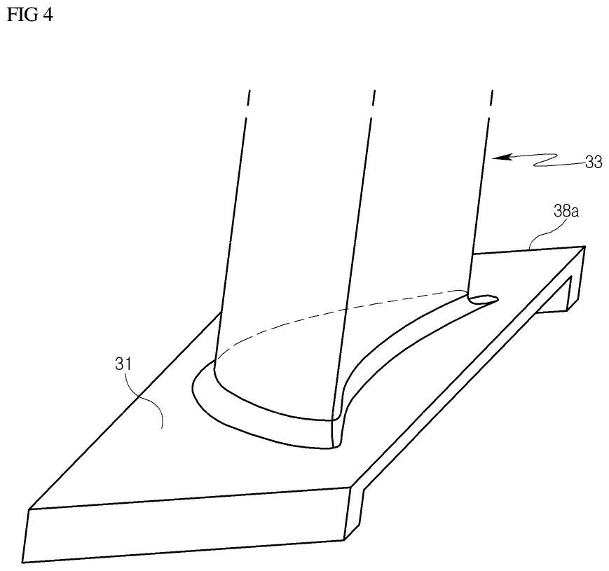

Referring to FIGS. 3 and 4, the turbine vane 33 includes a platform 31 and a tip 32, which are respectively coupled to end walls 38a and 38b. The entire radial height from the platform 31 to the tip 32 of the turbine vane 33 is termed as a span S. The turbine vane 33 is segmented into multiple span regions arranged along a span-wise direction, with each span region exhibiting a different airfoil shape. As an example, the number of spans regions may be three, though the turbine vane 33 may be segmented into any number of plural span regions.

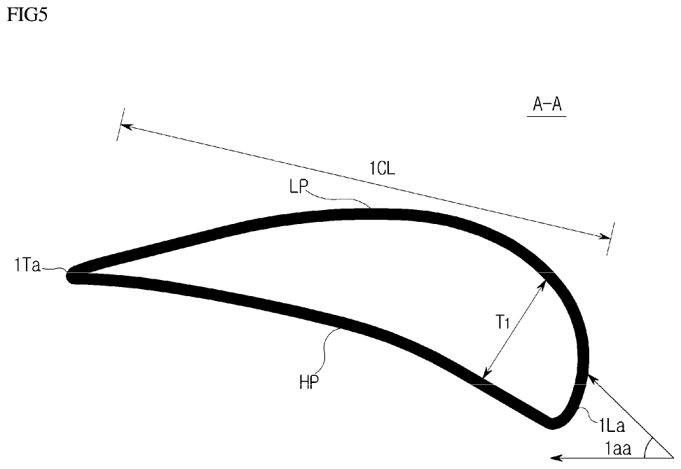

The above configuration, in which the airfoil shapes of the multiple span regions arranged across the span of the turbine vane differ, suppresses a secondary vortex passage flow that occurs when a hot gas is fed to the turbine vane 33, thereby minimizing the loss of the aerodynamic performance, which is attributable to an undesirable passage vortex on a suction side LP and on a pressure side HP (refer to FIGS. 5 to 7). To this end, the turbine vane 33 has an airfoil shape over the overall span S ranging from the platform 31 to the tip 32, in which as compared with a conventional art, the behavior of the hot gas flow differs at a leading edge La, a trailing edge Ta, the suction side LP, and the pressure side HP of the turbine vane 33.

In the present embodiment, as shown in FIG. 4, one or both of the junctions between the turbine vane 33 and an end wall, that is, the junction occurring next to the platform 31 or the tip 32 of the turbine vane 33, is itself provided with a junction airfoil rather than a conventional fillet. The junction airfoil is formed of a suction side surface 33a and a pressure side surface 33b. Therefore, since the role of a fillet is performed by the curvatures of the surfaces 33a and 33b of the junction airfoil, a turbulent flow is suppressed and a stable flow may form.

The turbine vane 33 includes a first span region S1 that is positioned near the platform 31 and has a first length in a span-wise direction from the platform 31 to the tip 32, a second span region S2 (also referred to as a middle span region) that is positioned next to the first span region S1 and has a second length in the span-wise direction, and a third span region S2 that is positioned near the tip 32 and next to the second span region S2 and has a third length in the span-wise direction. The first to third span regions S1 to S3 have different airfoil shapes, respectively. The maximum thickness of each of the airfoil shapes of the first to third span regions differs for each span region (S1, S2, S3). More specifically, the maximum thickness decreases stepwise from the first span region S1 to the third span region S3.

The respective lengths of the first, second, and third span regions S1, S2, and S3 may not be limited to the example illustrated in FIG. 3 and may differ from the example disclosed in the embodiment. For example, the length of the second span region S2 of the turbine vane may be greater than the length of either of the first and third span regions S1 and S3.

Regarding the turbine vane 33, since the maximum thickness of the third span region S3 is smaller than the maximum thickness of the first span region S1, when the hot gas flows through the turbine section, the pressure distribution increases first with an increasing distance from the platform 31 along the span, and decreases then with an increasing distance from the platform 31 along the span. That is, the pressure of the hot gas gradually increases with an increasing distance from the platform 31 across the span in the first span region S1 and the second span region S2, and then gradually decreases with an increasing distance from the platform 32 across the span in the third span region S3. This pressure distribution is maintained.

Generally, the pressure side HP is a region where fluid separation most easily occurs due to the secondary vortex when a hot gas flows through the turbine section. However, when the turbine vane 33 has a configuration as disclosed in the present embodiment, the flow stability of a hot gas can be improved.

Owing to the unique embodiment features of the turbine vane 33 having a specific airfoil shape according to span region, when a hot gas comes into contact with the turbine vane 33, the hot gas will flow along a curved streamline flow path. On the other hand, since conventional turbine vanes have a simple surface-processed contour, it was difficult for the conventional turbine vanes to guide the flow of a hot gas such that the hot gas flows along a curved streamline path.

In the turbine vane 33, the curvature of the leading edge La of each span region increases from the third span region S3 toward the first span region S1.

The leading edge La is positioned near the platform 31 and is a starting point of a flow path along which the coolant flows to reach the trailing edge Ta. In order to obtain uniform pressure distribution and improve the flow stability of a hot gas over the entire area of the turbine vane 33, it is desirable that the curvature of the leading edge of each span region increases from the third span region S3 to the first span region S1.

Referring to FIGS. 3 and 5, according to one embodiment of the present invention, the first span region S1 of the turbine vane 33 has an airfoil (airfoil shape) in which a first leading edge 1La is formed on the upstream side of the turbine vane 33 that first meets the hot gas and in which a first trailing edge 1Ta is disposed on the downstream side opposite to the first leading edge 1La. The first span region S1 has a first angle of attack 1aa corresponding to an angle between a direction of the first leading edge and an inflow direction of the hot gas, a first chord length 1CL that is the length of a linear line segment from the first leading edge 1La to the first trailing edge 1Ta, and a first maximum thickness T1 that is the greatest distance between the suction side LP and the pressure side HP of the airfoil.

In the present embodiment, the airfoils of the first span region S1, the second span region S2, and the third span region S3 are formed as illustrated in the drawings. For example, the airfoil of the first span region S1 has the first leading edge 1La and the first trailing edge 1Ta as illustrated in FIG. 5.

The first angle of attack 1aa determines a passage direction along which the hot gas flows until reaching the first trailing edge 1Ta. In the present embodiment, the first angle of attack 1aa ranges from 0° to 20° and occurs near the platform 31. When the first angle of attack 1aa is set to the above range, the flow of hot gas along the surface of the turbine vane may be stabilized.

The first chord length 1CL is a parameter influencing the flow of hot gas after the hot gas passes through the suction side LP and the pressure side HP when guiding the overall flow of the hot gas. In the present embodiment, the first chord length 1CL rages from 200 mm to 250 mm.

The first chord length 1CL is determined to prevent a passage flow of the hot gas from changing into a spiral vortex immediately after the hot gas collides with the first leading edge 1La. Therefore, the flow of the hot gas may be closely attached to the suction side LP or the pressure side HP when the hot gas flows toward the trailing edge. For this reason, a vortex flow can be weakened.

When the hot gas passes along the turbine vane 33 to reach the first trailing edge 1Ta, whether the stable flow of the hot gas can be maintained is determined according to the first chord length 1CL. Therefore, the above range of the first chord length 1CL is advantageous in terms of aerodynamic performance.

The first maximum thickness T1 is the greatest distance between the suction side LP and the pressure side HP of the airfoil of the first span region S1 and influences the velocity and the flow path of the hot gas. In the present embodiment, the first maximum thickness T1 ranges from 40 mm to 75 mm. This range should be maintained to obtain the optimum velocity and the optimum flow path of the hot gas.

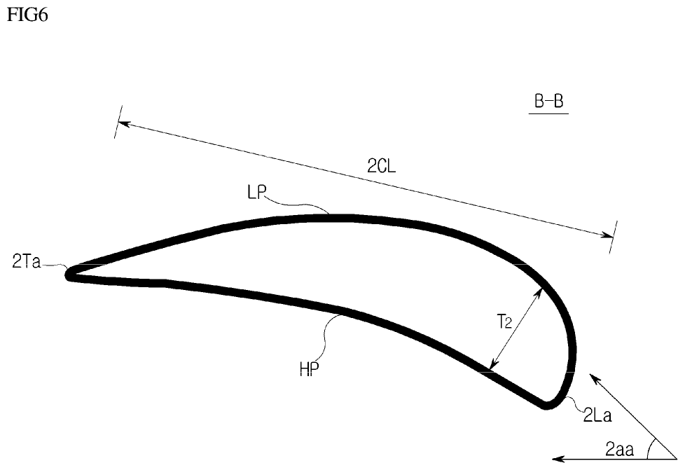

Referring to FIGS. 3 and 6, the airfoil of the second span region S2 of the turbine vane includes a second leading edge 2La formed on the upstream side of the turbine vane 33 and a second trailing edge 2Ta disposed on the downstream side. The airfoil of the second span region S2 has a second angle of attack 2aa corresponding to an angle between a direction of the second leading edge 2La and the inflow direction of the hot gas, a second chord length 2CL that is a linear length from the second leading edge 2La to the second trailing edge 2Ta, and a second maximum thickness T2 that is the greatest distance between the suction side LP and the pressure side HP of the airfoil.

The airfoil of the second span region S2 of the turbine vane 33 may differ in shape from the airfoil of the first span region S1. The second span region S2 is positioned in the middle of the overall span S of the turbine vane 33.

The airfoil of the second span region S2 guides the flow of the hot gas so as to minimize the flow separation of the hot gas until the hot gas reaches the second trailing edge 2Ta, thereby ensuring flow stability of the hot gas and suppressing generation of the turbine vane 33.

The second angle of attack 2aa determines a passage direction along which the hot gas flows until reaching the second trailing edge 2Ta. In the present embodiment, the second angle of attack 2aa ranges from 0° to 20°. When the second angle of attack 2aa is set to the above range, the flow of hot gas along the surface of the turbine vane may be stabilized.

The second angle of attack 2aa may be equal to the first angle of attack 1aa. However, the second angle of attack 2aa may differ from the first angle of attack 1aa.

The second chord length 2CL is a parameter influencing the passage flow of hot gas after the hot gas passes through the suction side LP and the pressure side HP when guiding the overall flow of the hot gas. In the present embodiment, the second chord length 2CL ranges from 180 mm to 230 mm.

With such a setting of the second chord length 2CL, it is possible to prevent the flow of the hot gas from changing into a spiral flow immediately after it collides with the second leading edge 2La. Therefore, it is possible to keep the flow of the hot gas attached to the suction side LP or the pressure side HP. Since the flow of the hot gas is not detached from the suction side LP or the pressure side HP while passing along the turbine vane, an unwanted spiral vortex flow will be weakened.

Since the second chord length 2CL is shorter than the first chord length 1CL, the time for the hot gas to reach the second trailing edge is shorter, which results in reduction in the likelihood of flow separation or which prevents problems associated with a pressure change. That is, the flow stability of the hot gas is maintained until the hot gas reaches the second trailing edge 2Ta along the surface of the turbine vane 33. Therefore, setting the second chord length 2CL to the above range is advantageous in terms of aerodynamic performance.

The second maximum thickness T2 is the greatest distance between the suction side LP and the pressure side HP of the second span region S2 and influences the velocity and the flow path of the hot gas. In the present embodiment, the second maximum thickness T2 ranges from 36 mm to 69 mm. This range may be maintained to obtain the optimum velocity and the optimum flow path of the hot gas.

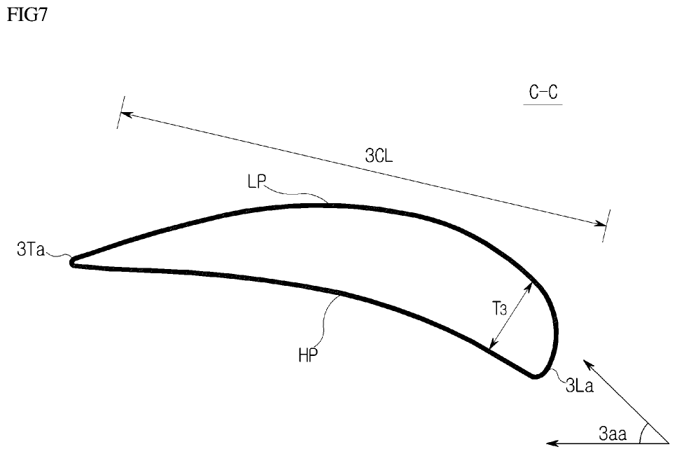

Referring to FIGS. 3 and 7, the airfoil of the third span region S3 includes a third leading edge 3La formed on the upstream side of the turbine vane 33 and a third trailing edge 3Ta disposed on the downstream side. The airfoil of the third span region S3 has a third angle of attack 3aa corresponding to an angle between a direction of the third leading edge 3La and the inflow direction of the hot gas, a third chord length 3CL that is a linear length from the third leading edge 3La to the third trailing edge 3Ta, and a third maximum thickness T3 that is the greatest distance between the suction side LP and the pressure side HP of the airfoil of the third span region S3.

The airfoil of the third span region S3, which is positioned near the tip 32, may differ in shape from the airfoil of the second span region S2. The airfoil of the third span region S3 of the turbine vane 33 guides the flow of the hot gas so as to minimize the flow separation until the hot gas reaches the third trailing edge 3Ta, thereby ensuring flow stability of the hot gas. Therefore, it is possible to suppress a vortex flow around the turbine vane 33.

The third angle of attack 3aa determines a passage direction along which the hot gas moves until reaching the third trailing edge 3Ta. In the present embodiment, the third angle of attack 3aa ranges from 0 to 20°. When the third angle of attack 3aa is set to the above range, the flow of the hot gas flowing along the surface of the turbine vane of the third span region S2 can be stabilized.

The third chord length 3CL is a parameter influencing the flow of the hot gas after the hot gas passes through the suction side LP and the pressure side HP when guiding the overall flow of the hot gas. In the present embodiment, the third chord length 3CL ranges from 180 mm to 200 mm.

With such a setting of the third chord length 3CL, it is possible to prevent the flow of the hot gas from changing into a spiral flow immediately after the hot gas collides with the third leading edge 3La such that the flow of the hot gas may not be detached from the suction side LP or the pressure side HP and may flow closely along the suction side LP or the pressure side HP. As a result, the spiral vortex flow will be weakened. That is, the flow stability of the hot gas is maintained until the hot gas reaches the third trailing edge 3Ta. Therefore, the above range of the third chord length 3CL is advantageous in terms of aerodynamic performance.

The third maximum thickness T3 is the greatest distance between the suction side LP and the pressure side HP and influences the velocity and the flow path of the hot gas. In the present embodiment, the third maximum thickness T3 ranges from 36 to 60 mm. When the above-described range of the third maximum thickness is required to obtain the optimum velocity and the flow path of the hot gas.

A gas turbine may include a multistage turbine and the turbine vane 33 described above may be applied to every stage, from the first to the last. In this case, the turbine vanes 33 may differ from stage to stage, such that the maximum thickness of the airfoil of each turbine vane may decrease from the first stage turbine to the last stage turbine. Alternatively, the turbine vanes 33 in every stage may be identical.

When the maximum thickness of the turbine vanes decreases from the first stage to the last stage, a smooth gas flow throughout the stages can be obtained. That is, the flow of the hot gas may not become unstable while the hot gas flows through the successive stages of the multistage turbine. Thus, until the hot gas reaches the last stage, the hot gas can stably move because the secondary vortex or the passage vortex is suppressed.

Therefore, the aerodynamic performance of the turbine is improved, the pressure loss attributable to the turbine vane 33 is reduced, and the stable flow of the hot gas can be attained.

In addition, in the case where the chord length gradually increases from the first stage to the last stage, it is possible to obtain the stable flow of the hot gas.

It is desirable that the flow of the hot gas is attached until the hot gas flows from the leading edge to the trailing edge along the surface of the turbine vane 33. To this end, the chord length of the turbine vane gradually increases from the first stage to the last stage. By adjusting the chord length of the turbine vane on a per-stage basis, it is possible to guide the flow of the hot gas under optimum conditions. The increase in the chord length of the turbine vane between two adjacent stages is uniform.

In the present embodiment, the curvature of the trailing edge Ta of each span region of the turbine vane decreases from the third span region S3 to the first span region S1. The curvature setting described above is determined based on changes in the flow speed of the hot gas according to position in the span-wise direction.

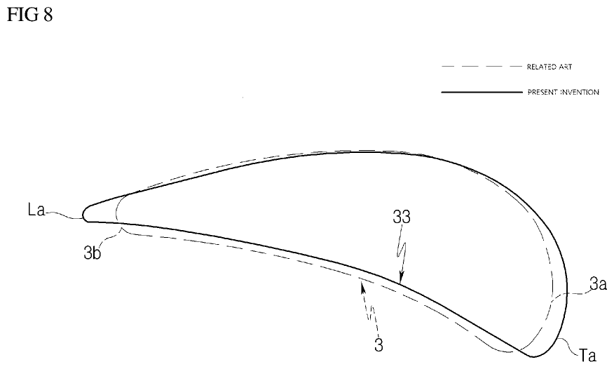

Referring to FIG. 8, the trailing edge Ta of the turbine vane 33 in the present embodiment is longer (extends farther) than the trailing edge 3b of the contemporary turbine vane 3. In addition, the turbine vane 33 according to the embodiment of the present invention is thinner than the contemporary turbine vane. Therefore, dynamic flow stability is improved, and the vortex generation around the trailing edge is reduced.

Therefore, when a hot gas flows through a turbine, generation of an unwanted vortex is suppressed and thus a smooth gas flow can be obtained.

Referring to FIGS. 5 to 7, in another embodiment of the present invention, a gas turbine includes a turbine vane 33 and a pair of end walls 38 respectively coupled to a platform 31 and a tip 32 of the turbine vane 33, in which the turbine vane 33 has an airfoil shape that differs in thickness according to location in a span-wise direction.

According to the present embodiment, the thickness of the turbine vane 33 varies from region to region across the overall span S. For example, the thickness of the turbine vane decreases stepwise or gradually across the overall span S from the platform 31 to the tip 32.

The turbine vane 33 described above may apply to each stage of a multistage turbine (i.e., from the first stage of a turbine to an Nth stage of the turbine). When the turbine vanes 33 of the turbine's multiple stages are configured as described above, a heat exchange performance is improved and a heat transfer efficiency is increased. Therefore, a cooling effect is enhanced.

In addition, since the turbine vanes are structured such that the thickness decreases from the first stage turbine to the last stage turbine, a smooth gas flow can be achieved. In this case, the flow of the hot gas does not become unstable until the hot gas passes through the turbine vanes of the last stage turbine, and occurrence of the secondary vortex or the passage vortex is suppressed along the flow path around the turbine vane 33.

Therefore, the aerodynamic performance of the turbine can be improved, the pressure loss at the turbine vane 33 can be reduced, and the flow stability of the hot gas can be maintained.

While the present disclosure has been described with respect to the specific embodiments, it will be apparent to those skilled in the art that various changes and modifications may be made without departing from the spirit and scope of the disclosure as defined in the following claims.

What is claimed is:

1. A gas turbine comprising:
a turbine vane that includes a vane platform and a vane tip and is segmented into a plurality of span regions arranged across a span between the vane platform and the vane tip, each span region of the turbine vane including a specific airfoil that occupies a corresponding span region of the plurality of span regions and extends from a leading edge of the turbine vane to a trailing edge of the turbine vane.

2. The gas turbine according to claim 1, wherein the specific airfoil is different for each span region of the plurality of span regions.

3. The gas turbine according to claim 1, wherein the specific airfoil has a different thickness for each span region of the plurality of span regions.

4. The gas turbine according to claim 1, wherein the plurality of span regions includes:
a first span region having a first length that extends from the vane platform toward the vane tip;
a second span region having a second length that extends from the first span region toward the vane tip; and
a third span region having a third length that extends from the second span region to the vane tip, and
wherein the turbine vane has a maximum thickness in each span region that decreases stepwise across the span from the first span region to the third span region.

5. The gas turbine according to claim 4, wherein the leading edge of the turbine vane has a curvature that increases across the span such that curvatures of the leading edges of the first span region, the second span region, and the third span region are arranged in decreasing order.

6. The gas turbine according to claim 4, wherein the trailing edge of the turbine vane has a curvature that decreases along the span such that curvatures of the trailing edges of the first span region, the second span region, and the third span region are arranged in increasing order.

7. The gas turbine according to claim 4, wherein the specific airfoil of the first span region includes a first leading edge and a first trailing edge and is formed to have at least one characteristic of
a first angle of attack corresponding to an angle between a direction of the first leading edge and an inflow direction of hot gas fed to the turbine vane,
a first chord length that is a linear length from the first leading edge to the first trailing edge, and
a first maximum thickness that is a greatest distance between a suction side of the specific airfoil and a pressure side of the specific airfoil.

8. The gas turbine according to claim 7, wherein the first angle of attack ranges from 0° to 20°, the first chord length ranges from 200 mm to 250 mm, and the first maximum thickness ranges from 45 mm to 75 mm.

9. The gas turbine according to claim 4, wherein the specific airfoil of the second span region includes a second leading edge and a second trailing edge and is formed to have at least one characteristic of
a second angle of attack corresponding to an angle between a direction of the second leading edge and an inflow direction of hot gas fed to the turbine vane,
a second chord length that is a linear length from the second leading edge to the second trailing edge, and
a second maximum thickness that is a greatest distance between a suction side of the specific airfoil and a pressure side of the specific airfoil.

10. The gas turbine according to claim 9, wherein the second angle of attack ranges from 0° to 20°, the second chord length ranges from 180 mm to 230 mm, and the second maximum thickness ranges from 36 mm to 69 mm.

11. The gas turbine according to claim 4, wherein the specific airfoil of the third span region includes a third leading edge and a third trailing edge and is formed to have at least one characteristic of
a third angle of attack corresponding to an angle between a direction of the third leading edge and an inflow direction of hot gas fed to the turbine vane,
a third chord length that is a linear length from the third leading edge to the third trailing edge, and
a third maximum thickness that is a greatest distance between a suction side of the specific airfoil and a pressure side of the specific airfoil.

12. The gas turbine according to claim 11, wherein the third angle of attack ranges from 0° to 20°, the third chord length ranges from 180 mm to 200 mm, and the third maximum thickness ranges from 36 mm to 60 mm.

13. The gas turbine according to claim 1, further comprising a pair of end walls respectively coupled to the platform and the tip of the turbine vane.

14. The gas turbine according to claim 13, further comprising a junction between the turbine vane and at least one end wall of the pair of end walls,
wherein the junction includes a junction airfoil formed by respective curvatures of a suction side surface and a pressure side surface.

15. The gas turbine according to claim 1, further comprising a multistage turbine including a plurality of turbine stages consisting of a first turbine stage through a last turbine stage,
wherein the turbine vane is provided to each turbine stage of the plurality of turbine stages, and the turbine vanes of the first through last turbine stages are respectively formed to have a maximum thickness that decreases from the first turbine stage to the last turbine stage.

16. The gas turbine according to claim 1, further comprising a multistage turbine including a plurality of turbine stages consisting of a first turbine stage through a last turbine stage,
wherein the turbine vane is provided to each turbine stage of the plurality of turbine stages, and the turbine vanes of the first through last turbine stages are respectively formed to have a chord length that increases from the first turbine stage to the last turbine stage.

17. A gas turbine comprising:
a multistage turbine including a plurality of turbine stages consisting of a first turbine stage through a last turbine stage, each turbine stage including a turbine rotor disk; and
a plurality of turbine vanes coupled to the turbine rotor disk of each turbine stage, each plurality of turbine vanes comprising:
a turbine vane that includes a vane platform and a vane tip and is segmented into a plurality of span regions arranged across a span between the vane platform and the vane tip, each span region of the turbine vane including a specific airfoil that occupies a corresponding span region of the plurality of span regions and extends from a leading edge of the turbine vane to a trailing edge of the turbine vane,
wherein the specific airfoil has a different thickness for each span region of the plurality of span regions.

18. The gas turbine according to claim 17, wherein the turbine vanes of the first through last turbine stages are configured to have a maximum thickness that decreases from the first turbine stage to the last turbine stage.

19. The gas turbine according to claim 18, wherein the turbine vanes of the first through last turbine stages are further configured to have a chord length that increases from the first turbine stage to the last turbine stage.

20. The gas turbine according to claim 17, wherein the plurality of span regions includes:
a first span region having a first length that extends from the vane platform toward the vane tip;
a second span region having a second length that extends from the first span region toward the vane tip; and
a third span region having a third length that extends from the second span region to the vane tip, and
wherein the turbine vane has a maximum thickness in each span region that gradually decreases from the first span region to the third span region.
